(19) United States
(12) Patent Application Publication
(10) Pub. No.: US 2009/0020611 A1
(43) Pub. Date: Jan. 22, 2009

(54) BI-OPTIC IMAGING SCANNER WITH PREPROCESSOR FOR PROCESSING IMAGE DATA FROM MULTIPLE SOURCES

(75) Inventors: William Sackett, Rocky Point, NY (US); Bradley S. Carlson, Huntington, NY (US); Michael Slutsky, Stony Brook, NY (US)

Correspondence Address: Tarolli, Sundheim, Covell & Tummino L.L.P, 1300 East Ninth Street, Suite 1700, Cleveland, OH, 44114, US

(73) Assignee: Symbol Technologies, Inc., Holtsville, NY (US)

(21) Appl. No.: 12/240,385

(22) Filed: Sep. 29, 2008

Related U.S. Application Data
(63) Continuation-in-part of application No. 11/240,420, filed on Sep. 30, 2005, now Pat. No. 7,430,682.

(51) Int. Cl. G06K 7/10

(52) U.S. Cl. 235/462.08; 235/462.41; 235/462.14; 235/462.01; 235/462.15

(57) ABSTRACT

Operating a bi-optic imaging scanner (300) to image a target bar code (308). The scanner (300) including a plurality of camera assemblies (C1-C6). An image processing system (330) including a preprocessor (332) simultaneously receiving captured image data (350) corresponding to image frames (IF1-IF6) of each of the plurality of camera assemblies (C1-C6) and storing the captured image data in a preprocessor memory (334). The preprocessor (332) generating statistical information (SI) regarding the captured image data (350) stored in the preprocessor memory (334) to facilitate identification of regions of the image frames (IF1-IF6) wherein an image (308′) of the target bar code (308) may be present. The preprocessor (332) transferring selected captured image data (350) corresponding to identified regions of the image frames to a main system memory (338). A main processor (336) operates on selected captured image data (350) to decode the target bar code (308).

### CROSS-REFERENCE TO RELATED APPLICATION

The present application is a continuation-in-part of and claims priority from U.S. application Ser. No. 11/240,420, filed Sep. 30, 2005, to be issued as U.S. Pat. No. 7,430,682 on Sep. 30, 2008. application Ser. No. 11/240,420 is incorporated herein in its entirety for any and all purposes.

### TECHNICAL FIELD

The invention relates to imaging and processing of target images and more particularly to the processing of image data from multiple sources.

### BACKGROUND

Various electro-optical systems have been developed for reading optical indicia, such as bar codes. A bar code is a coded pattern of graphical indicia comprised of a series of bars and spaces of varying widths, the bars and spaces having differing light reflecting characteristics. Systems that read and decode bar codes employing CCD or CMOS-based imaging systems are typically referred to as imaging-based bar code readers or bar code scanners.

The imaging bar code reader includes an imaging and decoding system including an imaging system for generating an image of a target bar code and decoding circuitry for decoding the imaged target bar code. Imaging systems include CCD arrays, CMOS arrays, or other imaging pixel arrays having a plurality of photosensitive elements or pixels. Light reflected from a target image, e.g., a target bar code is focused through a lens of the imaging system onto the pixel array. Output signals from the pixels of the pixel array are digitized by an analog-to-digital converter. Decoding circuitry of the imaging and decoding system processes the digitized signals and attempts to decode the imaged bar code.

Many modern imaging systems include a computing device that interfaces with video data. This interface is usually accomplished using a direct-memory-access (DMA) method or through a special hardware interface, such as a video port, that is part of the processor of the computing device. The object of these two approaches is to allow the computing device to process a relatively large amount of video data without overloading the computing bandwidth of the processor or the data access bandwidth of the memory bus.

Some imaging systems are designed to process data from more than one camera. Other systems process data from one or more cameras as well as packets of data about, for example, the video image being processed that has been computed by a co-processor. Some examples of co-processors include FPGA, ASICs, and DSPs. The use of co-processors allows the imaging system to be designed with relatively simple and inexpensive microprocessors.

While cost effective, inexpensive microprocessors tend to have limited bandwidth interfaces to external devices. These microprocessors usually include a video port that is a high bandwidth interface that is configured to accept data in a digital video format. In the digital video format the data is organized in a contiguous block, thus allowing the processor to accept all data with minimum effort in handshaking, even if the data is transmitted in multiple, discontinuous transmission sessions. Allowing discontinuous video transmission frees up the processor bandwidth to access and process data between these sessions, while at the same time reducing the amount of data that the sending component must buffer.

In imaging systems with multiple systems or additional data to be processed, the overhead involved in switching between the different data destinations may be so high that the use of an inexpensive microprocessor is not feasible.

### SUMMARY

Interleaving multiple logical data streams into a one physical data stream reduces overhead required to process the multiple logical data streams. Data from at least two sources is transmitted to a processor via a single video or other high-speed port such as an IEEE 1394 or “Firewire” port, DMA channel, USB port, or other peripheral device that is configured to receive successive frames of data according to concurrently received timing signals. A first array of data, such as a frame of pixels, is received from a first data source such as a camera having a first frame rate and a second array of data is received from a second data source such as a camera or logical component that provides statistics about the first array of data. The first and second arrays of data are interleaved to form a combined array of data. One or more timing signals are synthesized such that the combined array of data can be transmitted at a synthesized data transmission rate that is usually higher than the first rate to allow the system to keep up with the data being produced by the first data source. The combined array of data is transmitted to the processor according to the synthesized timing signals to enable transmission of the combined array of data as a simulated single frame of data.

The processor can be programmed to locate the first and second arrays of data from within the combined array of data after the transmission is made. In the case where the port is a video port, the timing signals can include a synthesized pixel rate and horizontal and vertical synchronization pulses.

In one aspect, the present invention concerns a multicamera imaging-based bar code reader for imaging a target bar code on a target object, the bar code reader comprising: a housing supporting a plurality of transparent windows and defining an interior region, a target object being presented to the plurality of windows for imaging a target bar code; an imaging system including a plurality of camera assemblies coupled to an image processing system, each camera assembly of the plurality of camera assemblies being positioned within the housing interior position and defining a field of view, each camera assembly including a sensor array and an imaging lens assembly for focusing the field of view of the camera assembly onto the sensor array, for each camera assembly of the plurality of camera assemblies, the sensor array being read out to generate image frames of the field of view of the camera assembly; an image process system including a preprocessor and a preprocessor memory coupled to the preprocessor, a main system processor and a main system memory coupled to the processor, the preprocessor simultaneously receiving captured image data corresponding to image frames of each of the plurality of camera assemblies and storing the captured image data in the preprocessor memory; the preprocessor generating statistical information regarding the captured image data stored in the preprocessor memory, the statistical information being analyzed by a selected one of the preprocessor and the main system processor to identify regions of the image frames wherein an image of the target bar code or a part thereof may be present; the preprocessor transferring portions of captured image data corresponding to identified regions of the image frames to the main system memory; and the main system processor operating on the portions of the captured image data transferred to the main system memory and attempting to decode an image of the target bar code.

In another aspect, the present invention concerns a method of operating a multicamera imaging-based bar code reader for imaging a target bar code on a target object, the steps of the method comprising: providing a reader including a housing supporting a plurality of transparent windows and defining an interior region, a target object being presented to the plurality of windows for imaging a target bar code; an imaging system including a plurality of camera assemblies coupled to an image processing system, each camera assembly of the plurality of camera assemblies being positioned within the housing interior position and defining a field of view, each camera assembly including a sensor array and an imaging lens assembly for focusing the field of view of the camera assembly onto the sensor array; for each camera assembly of the plurality of camera assemblies, the sensor array being read out to generate image frames of the field of view of the camera assembly at periodic intervals; providing an image processing system including a preprocessor and a preprocessor memory coupled to the preprocessor, an image process system including a main processor and a main system memory coupled to the processor; operating the reader to image a target bar code on a target object, for each camera assembly of the plurality of camera assemblies, the sensor array being read out at a predetermined frame rate to generate image frames of the field of view of the camera assembly at periodic intervals, the preprocessor simultaneously receiving captured image data corresponding to image frames of each of the plurality of camera assemblies and storing the captured image data in the preprocessor memory; the preprocessor generating statistical information regarding the captured image data stored in the preprocessor memory, the statistical information being analyzed by a selected one of the preprocessor and the main system processor to identify regions of the image frames wherein an image of the target bar code or a part thereof may be present; the preprocessor transferring portions of captured image data corresponding to identified regions of the image frames to the main system memory; and the main system processor operating on the portions of the captured image data transferred to the main system memory and attempting to decode an image of the target bar code.

In another aspect, the present invention concerns: an imaging system for use in multicamera imaging-based bar code reader having a housing supporting a plurality of transparent windows and defining an interior region, a target object being presented to the plurality of windows for imaging a target bar code on a target object, the imaging system comprising: a plurality of camera assemblies coupled to an image processing system, each camera assembly of the plurality of camera assemblies being positioned within the housing interior position and defining a field of view, each camera assembly including a sensor array and an imaging lens assembly for focusing the field of view of the camera assembly onto the sensor array, for each camera assembly of the plurality of camera assemblies, the sensor array being read out to generate image frames of the field of view of the camera assembly; an image process system including a preprocessor and a preprocessor memory coupled to the preprocessor, a main processor and a main system memory coupled to the processor, the preprocessor simultaneously receiving captured image data corresponding to image frames of each of the plurality of camera assemblies and storing the captured image data in the preprocessor memory; the preprocessor generating statistical information regarding the captured image data stored in the preprocessor memory, the statistical information being analyzed by a selected one of the preprocessor and the main system processor to identify regions of the image frames wherein an image of the target bar code or a part thereof may be present; the preprocessor transferring portions of captured image data corresponding to identified regions of the image frames to the main system memory; and the main system processor operating on the portions of the captured image data transferred to the main system memory and attempting to decode an image of the target bar code.

These and other objects, advantages, and features of the exemplary embodiment of the invention are described in detail in conjunction with the accompanying drawings.

### BRIEF DESCRIPTION OF THE DRAWINGS

FIG. 1 is a block diagram of functional components of an imaging scanner system that can be used to practice an embodiment of the present invention;

FIG. 2A is a functional block diagram illustrating the operation of imaging scanner processing components during practice of an embodiment of the present invention;

FIG. 2B illustrates one data format that can be used according to the embodiment of the present invention shown in FIG. 2A;

FIG. 3A is a functional block diagram illustrating the operation of imaging scanner processing components during practice of an embodiment of the present invention;

FIG. 3B illustrates one data format that can be used according to the embodiment of the present invention shown in FIG. 3A;

FIG. 4 is a flowchart representation of a method for processing multiple data streams according to one embodiment of the present invention;

FIG. 5 is an schematic perspective view of a bi-optic imaging scanner with six imaging cameras assemblies mounted within a scanner housing and capable of imaging six sides of a target object;

FIG. 6 is a schematic perspective view of the bi-optic imaging scanner of FIG. 5 with an item being presented for bar code reading

FIG. 7 is a schematic perspective view of the bi-optic imaging scanner of FIG. 5 with imaging ray traces shown for three of the six imaging camera assemblies, the imaging ray traces passing though a horizontal window of the scanner housing;

FIG. 8 is a schematic perspective view of the bi-optic imaging scanner of FIG. 5 with imaging ray traces shown for two of the six imaging camera assemblies passing though a vertical window of the scanner housing;

FIG. 9 is a schematic perspective view of the bi-optic imaging scanner of FIG. 5 with imaging ray traces shown for two of the six imaging camera assemblies passing though a vertical window of the scanner housing;

FIG. 10 is a schematic exploded perspective view of one of the six imaging camera assemblies;

FIG. 11 is a schematic block diagram of selected systems and electrical circuitry of the bar code reader of FIG. 5;

FIGS. 12A-12B are a schematic flowchart representation of a method of processing multiple data streams generated by the six imaging camera assemblies of FIG. 5 utilizing a preprocessor and preprocessor memory according to one embodiment of the present invention; and

FIGS. 13A-13B are a schematic flowchart representation of a method of processing multiple data streams generated by the six imaging camera assemblies of FIG. 5 utilizing a preprocessor and preprocessor memory according to another embodiment of the present invention.

### DETAILED DESCRIPTION

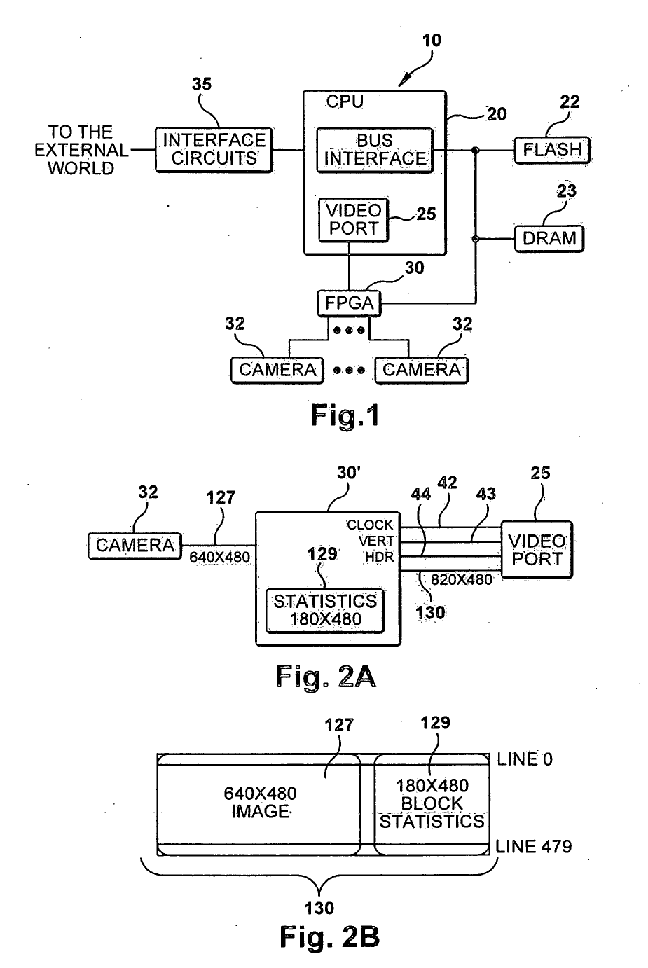

Referring to FIG. 1, a block diagram 10 of various electric circuits and circuit boards that can be employed as part of an imaging system to interleave multiple streams of data into a single video stream is shown. A microprocessor or CPU 20 receives digital signals from an FPGA circuit 30. The FPGA acquires image data from one or more sensor circuits, such as those in cameras 32 and computes statistical data about the image data. As will be described, the FPGA provides an augmented version of the image data that includes the statistical data through a video port 25 to the CPU 20. The FPGA also provides necessary timing signals to the video port. The CPU may also communicate by data line to flash memory 22 and DRAM memory 23, which comprise a computer-readable media, on which data and software for the system are stored. This information may include decoded data from a target optical code. The CPU transmits information to external components via interface circuits 35. One example of information that may be transmitted is video data for display on a monitor. For the purposes of this description imaging systems that employ one or three cameras are shown as examples, however it will be apparent to one of skill in the art that any number of cameras can be employed in practice of the invention. Additionally, other electrical circuits, boards, and processing units can be used to perform the various functions described herein.

In order to decode barcodes, an imaging scanner often uses a set of statistics from the image. The CPU uses the statistical information to identify portions of the image that likely contain the barcode or target. One example of a scanning system that employs statistics in the processing of images containing barcodes can be found in U.S. Pat. No. 6,340,114 to Correa et al. and assigned to the assignee of the present invention. The '114 patent is incorporated herein by reference in its entirety. In some imaging scanners the statistics are computed in software on an as-needed basis to identify the barcode in the image. This process of computing the statistics is relatively slow and generally not acceptable for high-speed scanners, especially those that include more than one camera. For these high speed cameras the image statistics can be computed in hardware by a custom component such as an FPGA on the video data as it is acquired from the camera. In this manner the statistics for all regions of the image can be computed in the same time it takes to acquire the image from the camera. However, the statistics must still be communicated to the CPU along with the video data.

Many CPUs have external DMA channels to efficiently transfer data to memory from an external device. However, when data is to be routed to different destinations, such as one or more streams of simultaneously generated video and statistics data, one DMA channel per data stream is usually required. Thus, each DMA channel is set up once and receives a large block of data that is sent in multiple small pieces to be stored sequentially in the CPU's memory. As the number of external data sources, such as cameras, increases the number of DMA channels may become a limiting factor in the capability of the CPU to receive data. For example, in many cases communications between the processor and an external device, such as a host computer or the internet, may require the use of a DMA channel. Therefore, it would be advantageous to use a single DMA channel for all camera data, even when multiple data streams are present. However, it would also be preferable that the DMA channel need not be set up multiple times (such as hundreds of times) within one image frame time, because each set up process is relatively expensive in terms of time and processing resources.

One possible approach to importing data into the CPU from multiple data sources is to use external memory to buffer the streams of data so that they are delivered to the CPU when large contiguous segments of data become ready to be sent. For example, if data corresponding to one complete frame of the image is buffered for each of two video streams, it is feasible to send the data to the CPU as two consecutive frames, each in a contiguous segment or together in a single segment. This technique reduces the overhead of DMA set up, however external memory for such a large amount of buffering can be prohibitively expensive.

Another solution to importing data from multiple sources on a single DMA channel is to interleave the multiple logical data streams into one physical data stream with very limited buffering for each of the logical data streams. The combined physical data can be transported into one contiguous block of processor memory. By organizing the data into one large stream (and memory block) the amount of overhead to switch between data streams is reduced significantly.

Certain inexpensive processors, such as the Freescale.RTM. MC9328MXL, lack sufficient support for efficient external DMA channels. One feasible way to input the large amount of data in the image and its statistics to the CPU is through the video or camera interface port. The video port is designed to accept only one video stream at a time, although there is often flexibility to define the video format, including the video frame size. When there is more than one data stream, such as one video stream plus one stream of statistics, the several data streams can be interleaved to form one physical stream of data. In the same way, video streams from multiple cameras can be interleaved into one stream, in the format of a video stream with a larger video frame, for communication through the video port. This technique works on any processor with a camera interface (digital video) port, and is especially advantageous when the digital video port is the only high bandwidth external interface. For example, this approach may be particularly useful in camera-enabled mobile phones where multiple cameras are deployed, or to improve the barcode reading performance of camera-enabled phones. The described embodiment communicates the resulting physical data stream through a video or camera port. However, the resulting physical data stream can be communicated through any high speed DMA channel, USB port, IEEE 1394 port, or other peripheral interface of a CPU.

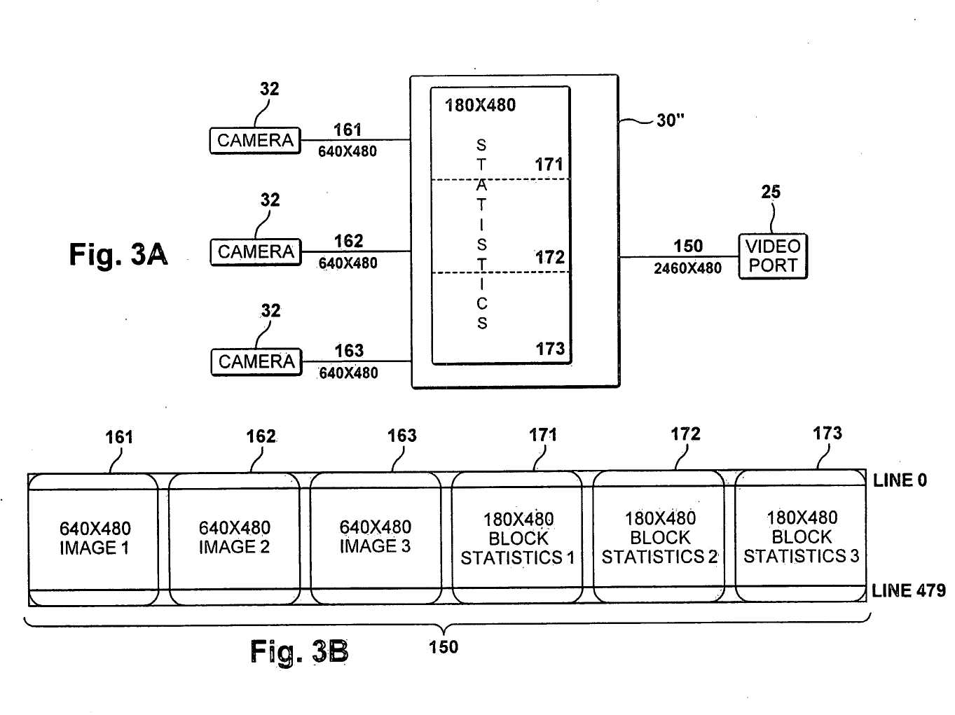

FIG. 2A illustrates an imaging system in which image data 127 from a single camera 32 and statistical data 129 from an FPGA 30′ that computes statistics on the data from the camera are interleaved to form a single block of data 130 that is formatted to simulate video data from a single 820.times.480 pixel video frame. The resulting interleaved data format is shown-in FIG. 2B. The statistics 129 are computed on 8.times.8 pixel blocks of the image resulting in an array of 80.times.60 blocks of statistics for the 640.times.480 VGA image 127. Each block of statistics contains 18 bytes of data resulting in 80.times.60.times.18=86,400 bytes of statistics data per image. The logic in the FPGA 30′ buffers enough of the image to compute the statistics and outputs the image data and statistics data interleaved with each other. The output is formatted as video data so that it can be efficiently transferred to the CPU's memory through the CPU's video or camera interface port 25. The FPGA receives the image (in this case 640.times.480 pixels) from the camera 32 using the pixel clock horizontal and vertical synchronization signals of the camera. The FPGA synthesizes a new pixel clock having a signal shown as 42, and horizontal and vertical synchronization signals 44, 43 that correspond to an image size of 820.times.480 pixels (the original 640.times.480 image and 180.times.480 statistics). The rate of the new pixel clock is greater than the rate of the camera's pixel clock so that the synthesized video stream has a frame rate equal to that of the camera. In other words, if the camera takes 33 milliseconds to transfer its 640.times.480 image to the FPGA, then the FPGA needs to take approximately 33 milliseconds to transfer its 820.times.480 pixel augmented image to the CPU. The synthesized pixel clock is faster than the pixel clock of the camera, and the synthesized horizontal synchronization signal, which signifies each line of the frame, is maintained high once for each 820 pixel clocks. The vertical synchronization signal is high for 480 lines just like that of the camera.

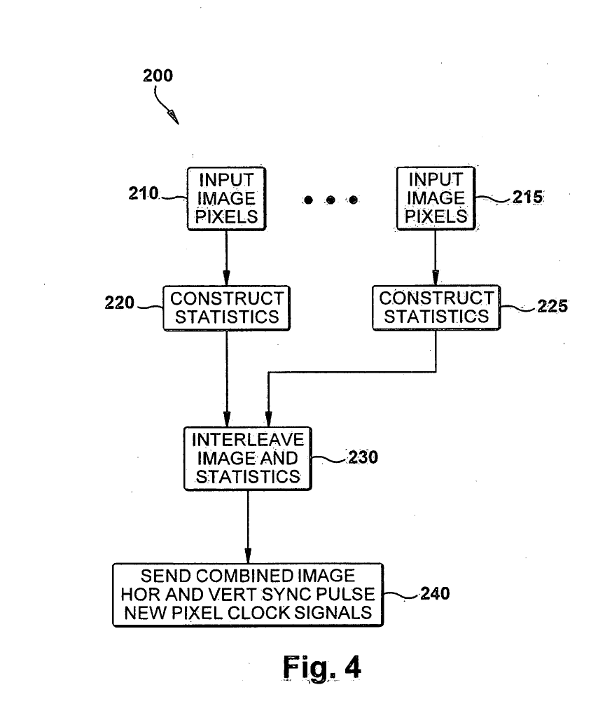

FIGS. 3A and 3B show an imaging system in which data from three cameras are interleaved. FIG. 3B shows one possible format for a data block 150 used to input image data 161, 162, 163 and statistics 171, 172, 173 from three cameras into a single video port. The video port of a typical CPU is capable of operating up to 48 MHz. The amount of data that must be transferred per second for the three camera/statistics configuration is ((640×480 (for the image) +180×480 (for the statistics)) bytes/frame×3 cameras×30 frames/second) or approximately 35.4 MB/second. Since the video port accepts one byte of data at a time, there is sufficient bandwidth to pass the data and statistics from three cameras to the processor through the video port. The FPGA acquires images from the three cameras in parallel, and the FPGA computes the statistics on the 3 images. The synthesized horizontal synchronization signal is active for 2460 pixel clocks.

The organization of the interleaved data is determined by the FPGA and can be arbitrarily selected to fit a particular need. The formats shown in FIGS. 2B and 3B are configured such that when the interleaved data is received by the CPU it does not have to de-interleave it. The CPU's software is written using memory pointers and appropriate pointer arithmetic to access the data from its acquired place in memory. For example, the series of blocks of image data 127 in FIG. 2B is no longer stored in a contiguous block, but can still be accessed as a 2-dimensional array as usual, except that certain addressing methods must change. For example, from a given pixel the one below it is offset by (640+180) pixels instead of 640.

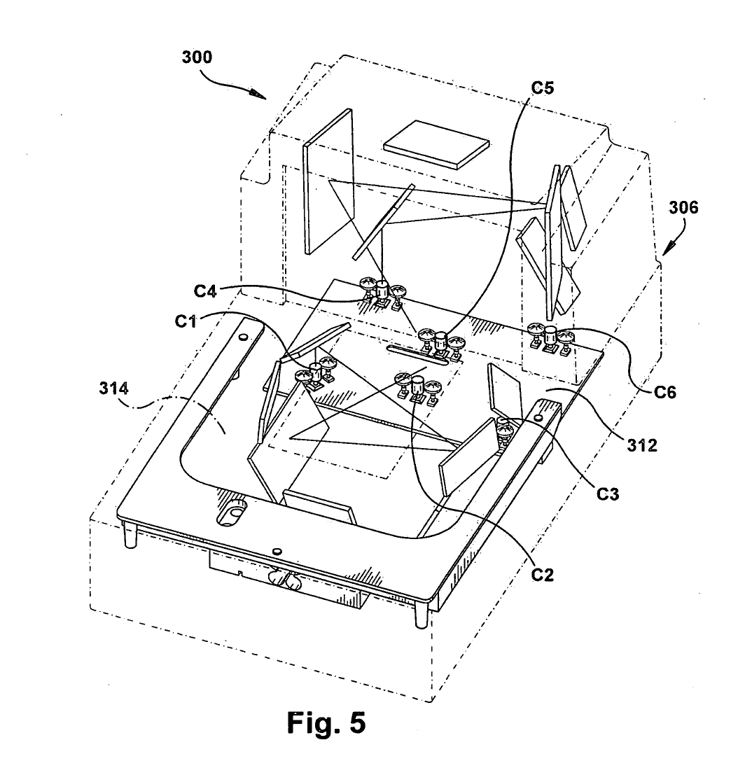

One possible method 200 that can be employed by the FPGA to construct simulated video data for input into a video port is shown in flowchart form in FIG. 4. The FPGA has logic components that are configured ahead of time to interleave the image and statistics data as well as send the necessary timing signals to the video port based on the expected size of the image and statistic data that will be encountered in the particular application. At 210 and 215 image pixels are input and at 220 and 225 statistics are computed. At 230 the image and statistics data are interleaved into an augmented video frame and at 240 the simulated video image and appropriate horizontal and vertical synchronization signals as well as the timing signals from the revised pixel clock are provided to the processor via the video port.

It can be seen from the foregoing description that interleaving multiple logical data streams and formatting them as a simulated single frame of data can allow the transfer of large quantities of data from multiple sources into a CPU using a single video port.

Bi-Optic Imaging Scanner

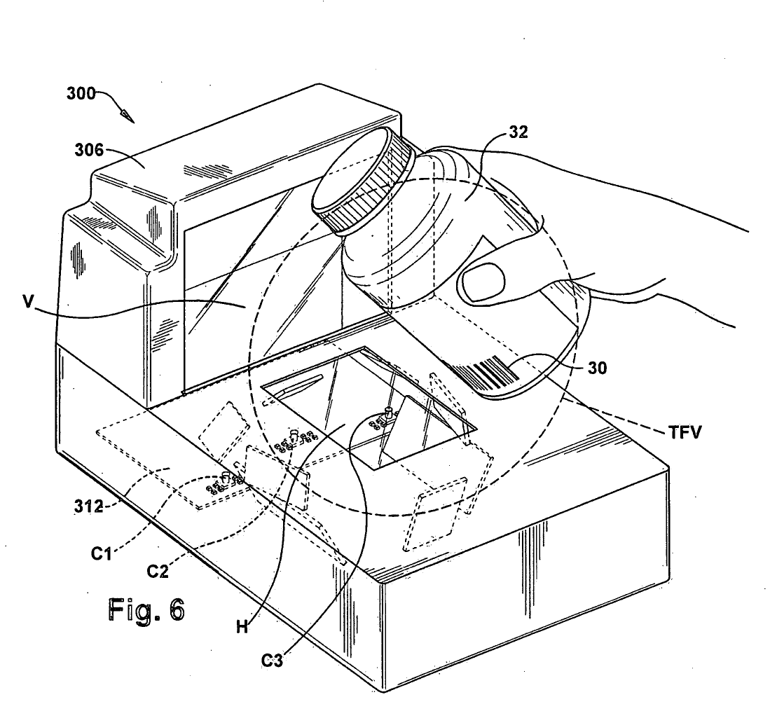

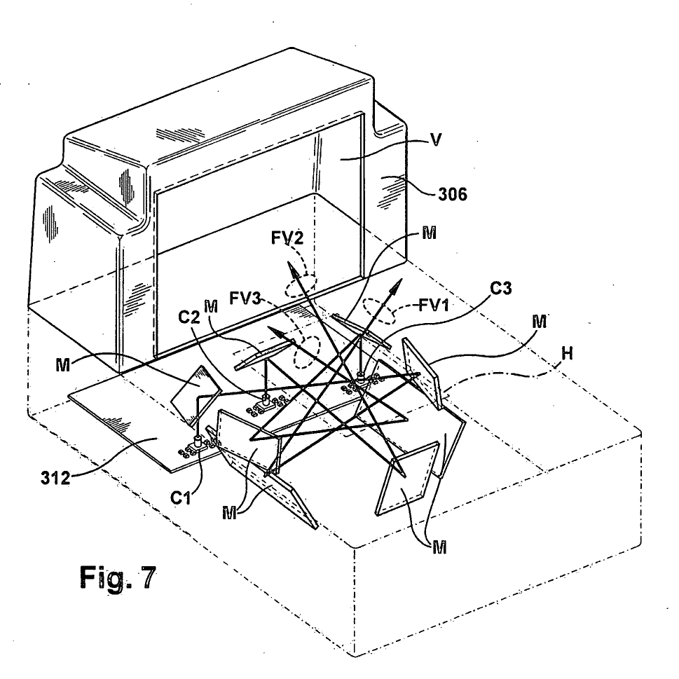

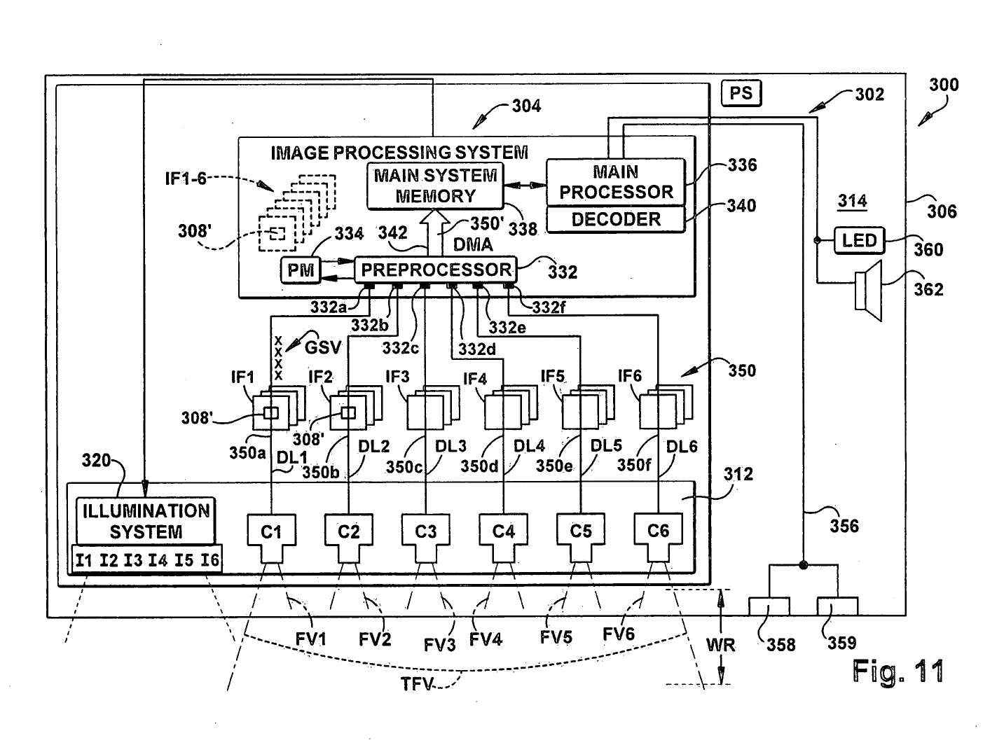

One exemplary embodiment of a multicamera imaging-based bar code reader, often referred to as an imaging bi-optic scanner, is shown generally at 300 in FIGS. 5-9. The scanner 300 includes circuitry 302 comprising an imaging system 304. The imaging system 304 includes six imaging camera assemblies C1-C6 disposed within an L-shaped scanner housing 306. The scanner housing 306 supports a transparent horizontal window H and a vertical transparent window V. The use of six camera assemblies C1-C6 and a plurality of mirrors M precisely positioned with the housing 306 permits a target bar code 308 affixed to a target object 310 to be successfully read (that is, imaged and decoded) regardless of the orientation of the target bar code 308 with respect to the scanner housing 306 provided that the target bar code 308 is within an overall, composite field of view TFV (shown schematically three dimensional generally spherical shape in FIG. 6) of the six camera assemblies C1-C6. Additional features and characteristics of the six camera bi-optic scanner 300 are disclosed in co-pending U.S. Ser. No. ______, (attorney docket no. SYM-018631 US PRI—Symbol disclosure no. SBL-08251), entitled “IMAGING DUAL WINDOW SCANNER WITH PRESENTATION SCANNING” filed Sep. 30, 2008, inventors Edward Barkan and Mark Drzymala, assigned to the assignee of the present invention. The aforesaid co-pending application (attorney docket no. SYM-018631 US PRI—Symbol disclosure no. SBL-08251) is incorporated herein in its entirety by reference.

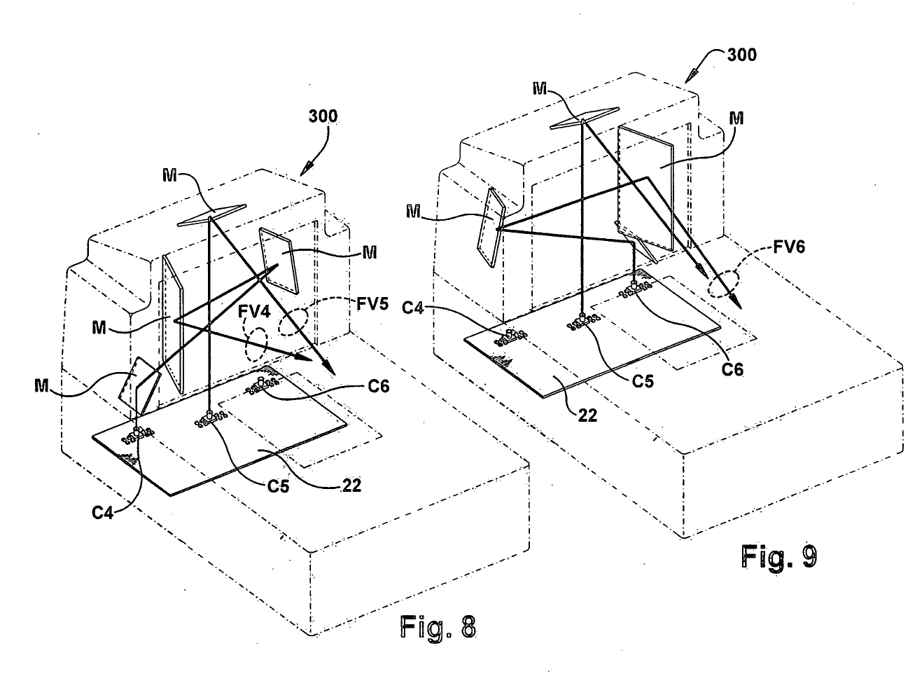

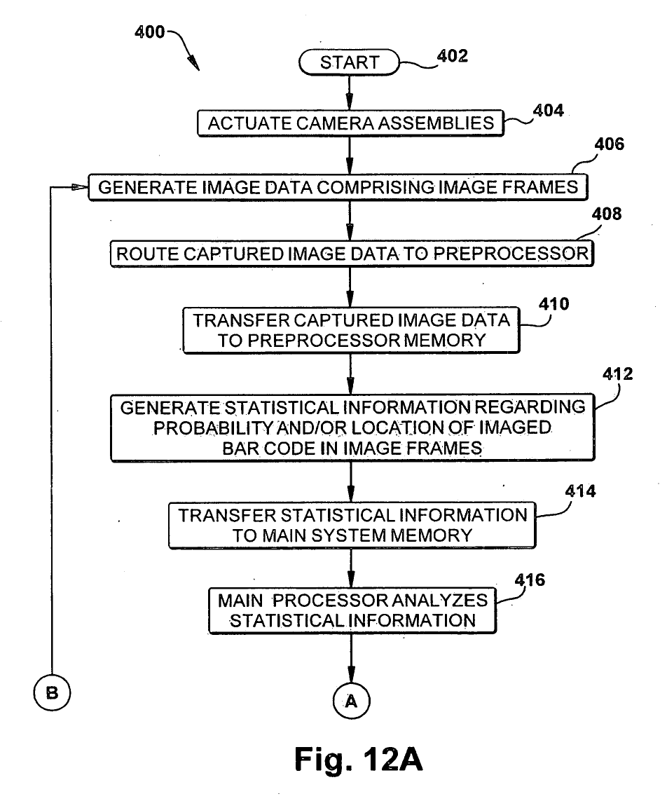

Each of the six imaging camera assemblies C1-C6 are mounted on a planar mounting board, such as a printed circuit PC board 312, disposed within an interior region 312 of the housing 306. The camera assemblies C1-C6, when actuated by the imaging system 304 produce raw gray scale images of their respective fields of view FV1-FV6. Mounting the camera assemblies C1-C6 onto the PC board 312 advantageously permits easy assembly of the camera assemblies and precise alignment of the camera assemblies within the housing 306. As can best be seen in FIG. 10 which shows an enlarged view of camera assembly C1, each of the six imaging camera assemblies C1-C6 includes a 2D sensor array 316 mounted to the PC board 312, an imaging lens assembly 318 positioned above and adjacent the sensor array 316 for focusing light from a two dimensional field of view FV1 (shown schematically in FIGS. 7 & 10) onto the sensor array 316.

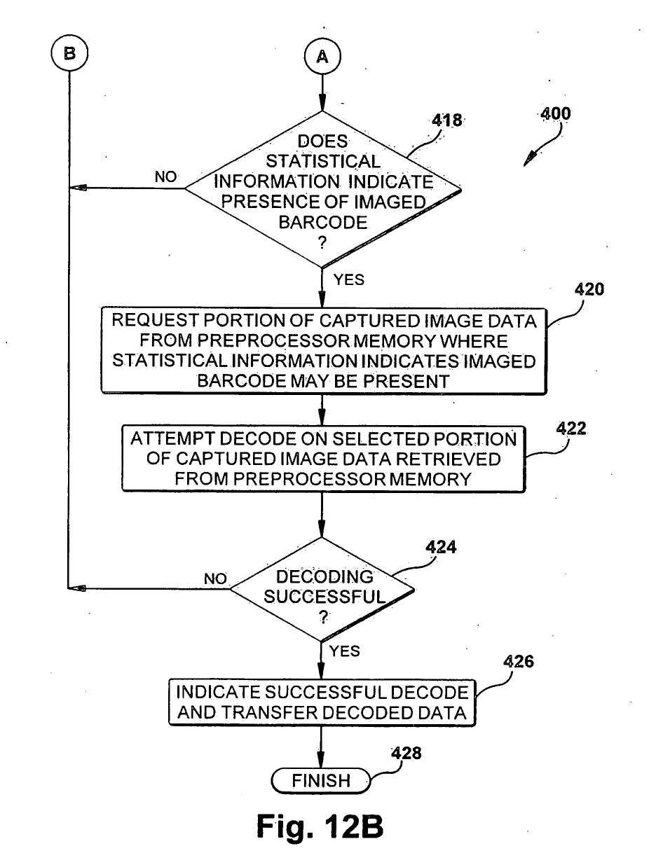

As can be seen in FIG. 6, the overall, composite field of view TFV is in a region of the windows H, V, outside the housing 306. Because each camera C1-C6 has an effective working range WR (shown schematically in FIG. 11) over which a target bar code 30 may be successfully imaged and decoded, there is an effective target area in front of the windows H, V within which the target bar code 308 presented for reading may be successfully imaged and decoded.

In one exemplary embodiment, the sensor array 316 is a Micron WVGA, 60 fps, global shutter sensor. In one exemplary embodiment, imaging lens assemblies 318 of the middle two camera assemblies C2, C5 are non-anamorphic with approximately a 12 inch focus, while the remaining four corner camera assemblies C1, C3, C4, C6 are anamorphic with approximately 20 inch focus. Anamorphic imaging lenses advantageously have an aspect ratio of the field of view FV such that the field of view properly “fits” or corresponds to the size of the horizontal or vertical window H that the field of view is projected through and provides for increased resolution in one axis for tilted bar codes. In one exemplary embodiment, each of the imaging camera assemblies C1-C6 provide sequential image capture every 16 milliseconds.

The camera assemblies C1-C6 further include an illumination assembly 320 comprising a pair of surface mount LEDs 322 flanking the sensor array 316 and a corresponding pair of illumination lenses 324 positioned above each of the LEDs 322. The optics 324 of the illumination assemblies 320 provide for narrow fields of view of the illumination assemblies to substantially match the narrow fields of view FV1-FV6 of the imaging lens assemblies 318.

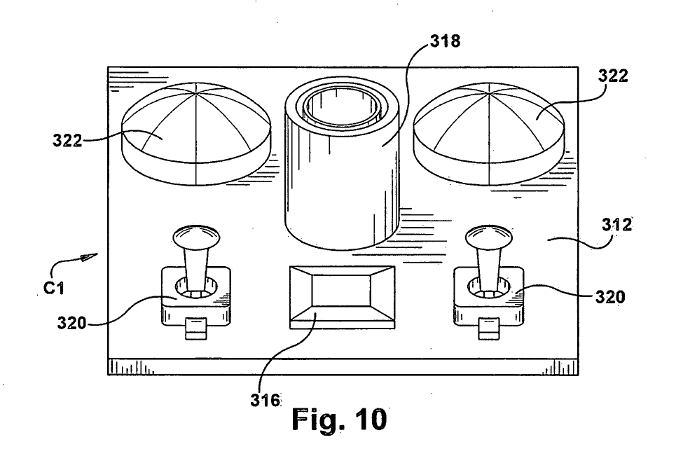

As can be seen from the imaging ray traces for the camera assemblies C1-C6 shown in FIGS. 7-9, each camera assembly imaging field of view FV1-FV6 is reflected/projected by one or more folding mirrors M such that for camera assemblies C1-C3, the two dimensional imaging fields of view FV1-FV3 (shown schematically in FIG. 7) pass through the horizontal window H of the housing 306, while for camera assemblies C4-C6, the imaging fields of view FV4-FV6 (shown schematically in FIGS. 8 & 9) pass through the vertical window V of the housing 306. Of course, the illumination of the illumination assemblies 320 is similarly reflected/projected by the fold mirrors M.

The imaging system 304 includes an image processing system 330 that operates on image data 350 (shown schematically FIG. 11) in generated by the camera assemblies C1-C6 when actuated. The camera assemblies C1-C6 are typically actuated from a power-saving sleep mode when a target object 310 is brought with the composite field of view TFV of the imaging system 304. The image processing system 330 analyzes the image data 350 in an attempt to read a target bar code 308 on the target object 310 assuming the target bar code 308 is brought within the composite field of view TFV of the scanner 300. The image data 350 is comprised of sequential image frames shown schematically as image frames IF1 generated by camera assembly C1, image frames IF 2 generated by camera assembly C2, etc. Each of the image frames IF1-IF6 is comprised of a series of gray scale pixel values read out on a periodic basis from the camera assemblies C1-C6.

Each camera assembly C1-C6 of the imaging system 304 captures a series of image frames of its respective field of view FV1-FV6. The series of image frames for each camera assembly C1-C6 is shown schematically as IF1, IF2, IF3, IF4, IF5, IF6 in FIG. 11. Each series of image frames IF1-IF6 comprises a sequence of individual image frames (shown in FIG. 11) generated by the respective cameras C1-C6. As seen in the drawings, the designation IF1, for example, represents multiple successive image frames generated by the camera assembly C1. As is conventional with imaging cameras, the image frames IF1-IF6 are in the form of respective digital signals representative of raw gray scale values generated by each of the camera assembly C1-C6.

For each camera assembly C1-C6, electrical signals are generated by reading out of some or all of the pixels of the pixel array after an exposure period generating a gray scale value digital signal. This occurs as follows: within each camera, the light receiving photosensor/pixels of the sensor array are charged during an exposure period. Upon reading out of the pixels of the sensor array, an analog voltage signal is generated whose magnitude corresponds to the charge of each pixel read out.

The image signals of each camera assembly C1-C6 represents a sequence of photosensor voltage values, the magnitude of each value representing an intensity of the reflected light received by a photosensor/pixel during an exposure period. Processing circuitry of each of the camera assemblies C1-C6, including gain and digitizing circuitry (not shown), then digitizes and coverts the analog signal into a digital signal whose magnitude corresponds to raw gray scale values of the pixels. The series of gray scale values GSV (FIG. 11) represent successive image frames generated by the camera assembly. The digitized signal comprises a sequence of digital gray scale values typically ranging from 0-255 (for an eight bit A/D converter, i.e., 2⁸=256), where a 0 gray scale value would represent an absence of any reflected light received by a pixel during an exposure or integration period (characterized as low pixel brightness) and a 255 gray scale value would represent a very intense level of reflected light received by a pixel during an exposure period (characterized as high pixel brightness). In some sensors, particularly CMOS sensors, all pixels of the sensor pixel array 316 are not exposed at the same time, thus, reading out of some pixels of the sensor array 316 may coincide in time with an exposure period for some other pixels of the sensor array. Image data 350 includes the digitized gray scale values generated by each of the camera assemblies C1-C6, the image data 350 corresponds to a series of image frames, e.g., IF1, IF2, IF3, . . . , IF6, each series of image frames being generated simultaneously by a respective one of the camera assemblies during an imaging/bar code reading session.

The image processing system 330 controls operation of the cameras C1-C6. The cameras C1-C6, when operated during a bar code imaging/reading session, generate digital signals. The signals are raw, digitized gray scale values which correspond to a series of generated image frames for each camera C1-C6. The image data 350 includes, for example, for the camera C1, signals 350a corresponding to digitized gray scale values corresponding to a series of image frames IF1, for the camera C2, signals 350b corresponding to digitized gray scale values corresponding to a series of image frame IF2, for the camera C3, signals 350c corresponding to digitized gray scale values corresponding to a series of image frames IF3, for the camera C4, signals 350d corresponding to digitized gray scale values corresponding to a series of image frame IF4, for the camera C5, signals 350e corresponding to digitized gray scale values corresponding to a series of image frames IF5, for the camera C6, signals 350f corresponding to digitized gray scale values corresponding to a series of image frame IF6.

The image processing system 330 comprises the preprocessor 332, the preprocessor memory 334, a main system processor 336 and a main system memory 338. Advantageously, the scanner 300 employs the preprocessor 332 and the preprocessor memory 334 such that the image data 350 from all six camera assemblies is stored in the preprocessor memory 334 and analyzed by the preprocessor 332 to generate statistical information SI regarding the image data 350. Based on the statistical information SI generated by the preprocessor 332, only a selected portion 350′ of the totality of the image data 350 is transferred to the main system memory 338 and used by the main system processor 336 in an attempt to decode an image 308′ of the target bar code 308 found in the selected image data 350′. The selected image data 350′ is shown schematically in FIG. 11 being transferred to main system memory on DMA channel 342.

The statistical information SI generated by the preprocessor 332 includes information regarding the probability and/or location of an image 308′ of the target bar code 308 or some portion of the imaged target bar code 308′ within a captured image frame. In other words, the statistical information SI facilitates the determination of whether a particular image frame in the sequence of image frames IF1-IF6 being continuously generated by a respective image cameras C1-C6: 1) has an imaged bar code 308′ or a portion of an imaged bar code 308′ within the image frame?; and 2) if so, where is the imaged bar code 308′ or portion thereof located within the image frame gray scale values?

By way of example and without limitation of the statistical information SI to any particular characteristics or methods, the statistical analysis performed by the preprocessor 332 for an image frame in the series of image frames IF1-IF6 may include dividing the image frame into nonoverlapping 8×8 pixel squares. For each pixel square, the preprocessor 332 may calculate statistics including: 1) the average pixel gray scale brightness value (i.e., 0 gray scale value being extremely dark and 255 gray scale value being extremely bright or light); 2) the white level (corresponding to the third brightest pixel in the square); 3) the dark level (corresponding to the third darkest pixel in the square); 4) the contrast (an average gray scale value of the white level and the dark level); 5) the primary vector; and 6) the secondary vector, among others.

At a conceptual, schematic level, the primary vector can be thought of as follows: The primary vector represents the direction and magnitude of the maximum contrast change within the 8×8 pixel block. For example, if there was an 8×8 pixel block with 32 pixels on the right half of the block being very light (high gray scale values) and 32 pixels on the left half of the block being very dark (low gray scale values), the primary vector would be a vertical oriented vector line dividing the 32 bright and the 32 dark pixels. The primary vector includes both a direction and magnitude wherein the magnitude is a function of how large the difference is between the gray scale values of the pixels on opposite sides of the primary vector. In one exemplary embodiment, to limit the scope of the calculations needed to be performed by the preprocessor 332, the direction of the primary vector may be limited to one of 20 directions (the directions equally divided from −90° to +90° degrees). In an exemplary embodiment, schematically what is done is that for each pixel in the 8×8 pixel block or array, a difference between the gray scale value of the pixel and each of its closest neighbors to the top, bottom, left and right is calculated. From this, an approximate direction and magnitude of the contrast change between the pixel and its neighbors is calculated. The magnitude is added to one of 20 buckets or running sums corresponding to the 20 directions. After all the pixels are processed in this way, the direction corresponding to the bucket with the largest running sum is selected as the direction of the primary vector and the running sum from this bucket is the primary vector magnitude.

After the primary vector is found, a secondary vector may be found wherein the secondary vector is a line that produces the second largest direction of contrast change after the primary vector. The secondary vector is useful in locating regions of an image frame where a 2D imaged bar code 308′ may be present. As noted earlier, certain imaging statistics are discussed in detail in the aforesaid U.S. Pat. No. 6,340,114 to Correa et al., which is incorporated by reference in its entirety herein.

As will be explained below, after the statistical information SI is generated by the preprocessor 332, the information SI is subsequently analyzed by either the preprocessor 332 or the main system processor 336. The analysis of the statistical information SI is performed to identify a region or regions of one or more image frames IF1-IF6 where a bar code image 308′ is likely to be found or may be found in an image frame. For example, the analysis of statistical information SI would include looking a region of an image frame wherein a group of adjacent pixel squares have similar primary vector directions and magnitude. Such a situation would be indicative of lines in adjacent pixel squares each extending in the same direction. Such a grouping of lines extending in the same direction would likely be an image 308′ of the target bar code 308, for example, an imaged ID bar code.

Use of the preprocessor 332 and preprocessor memory 334 advantageously minimizes the required direct memory access (DMA) memory bandwidth required by the main system memory 338 and the main processor 336 by reducing the amount of image data 350 required to be transferred to the main system memory 338. Further, available main system processors 336 do not include six image sensor ports. The preprocessor 332 includes six image sensor ports 332a-332f and comprises digital logic, memory and may, optionally, contain a CPU, thus, the preprocessor 332 of the present invention allows simultaneous reception and analysis of video data 350 from all six camera assemblies C1-C6. The preprocessor 332 may be implemented with a field programmable gate array (FPGA), application specific integrated circuit (ASIC), or as discrete components.

When the imaging system 304 is actuated from the sleep mode to the imaging session mode, the preprocessor 332 simultaneously receives the raw image data 35 generated by the camera assemblies C1-C6 via data lines DL1-DL6 that are coupled from the camera assemblies C1-C6 to video input ports 332a-332f of the preprocessor 332. The main system processor 336 includes decoding circuitry or a decoder 340 that analyzes the gray scale image data from the cameras C1-C6 and decodes an image 308′ of the target bar code 308, if present in the image data analyzed by the main system processor 336.

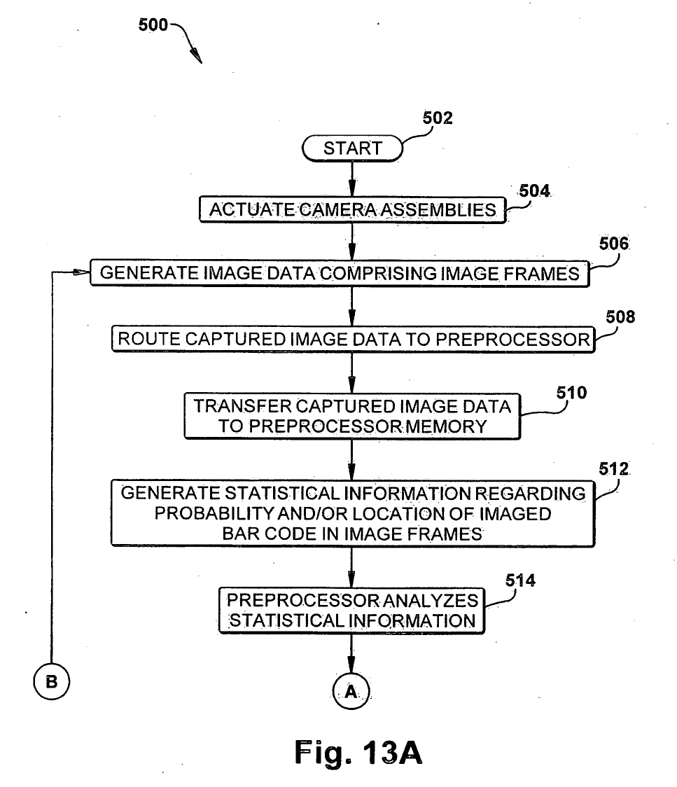

In one exemplary method of operation, the imaging system 304 and image processing system 330 assembly operate as shown generally at 400 in the flowchart of FIG. 12. An imaging/bar code reading session starts at 402 when the scanner 300 is awakened from a sleep mode upon an object being detected within the composite field of view TFV. At step 404, the image processing system 330 actuates the camera assemblies C1-C6 and, at step 405, the camera assemblies generate image data 350 comprising image frames IF1-IF6. At step 408, the data lines DL1-DL6 route the image data 350 to the preprocessor 332. At step 410, the image data 350 is stored in the preprocessor memory 334. At step 410, the preprocessor 332 generates statistical information SI (FIG. 11) regarding the image data 350 and, particular, with respect to each captured image frame IF1-IF6.

At step 414, the statistical information SI generated by the preprocessor 332 is transferred to the main system memory 338. At step 416, the main system processor 336 analyzes the statistical data to determine, at step 418, whether the statistical information SI indicates that an imaged bar code 308′ or a portion of an imaged bar code 308′ is present in one or more of the series of image frames IF1-IF6. If the answer to the determination made by the main processor 336 at step 416 is yes, then, at step 420, the main processor 336 will instruct the preprocessor 332 to retrieve and transfer a selected portion 350′ of the captured image data 350 stored in the preprocessor memory 334 that corresponds to the area/location or areas/locations of one or more image frames IF1-IF6 where the main processor 336 has determined an imaged bar code 308′ or portion thereof is present. The selected image data 350′ is transferred from the preprocessor memory 334 to the main system memory 338 via a reduced bandwidth DMA channel 342.

At step 418, if it is determined by the main processor 336 that the statistical information SI generated by the preprocessor 332 does not indicate the present of an imaged bar code 308′, then the process returns to step 406 where newly generated image data 350 is analyzed by the preprocessor 332. It should be noted, of course, that during the course of a bar code imaging/reading session, the preprocessor memory 334 continuously stores image data 350 as image data is continually generated by the imaging camera C1-C6 during the session and, correspondingly, the preprocessor 332 continuously analyzes the generated image data 350 and continues to generate statistical information SI regarding the generated image data.

At step 422, when the selected portion 350′ of the captured image data 350 corresponding to an imaged bar code 308′ is transferred from the preprocessor memory 334 to the main processor memory 338, the main system processor 338 (including the decoder 340) acts on the selected image data 350′ and attempts to decode the imaged bar code 308′. At step 424, if decoding of the imaged bar code 308′ from the selected image data 350′ is successful, then, at step 426, an indication is given of a successful decode and, at step 428, the imaging session is terminated.

Upon a successful reading of the target bar code 308, decoded data 356, representative of the data/information coded in the target bar code 308 is then output via a data output port 358 (FIG. 11) and/or displayed to a user of the reader 300 via a display 359. Additionally, a visual and/or audible signal may be generated by the reader 300 to indicate to the user that the target bar code 308 has been successfully imaged and decoded. The successful read indication may be in the form of illumination of a light emitting diode (LED) 360 (FIG. 11) and/or generation of an audible sound by a speaker 362 upon appropriate signal from the decoder 340. If at step 424 decoding is not successful, the process reverts back to step 406, as discussed previously.

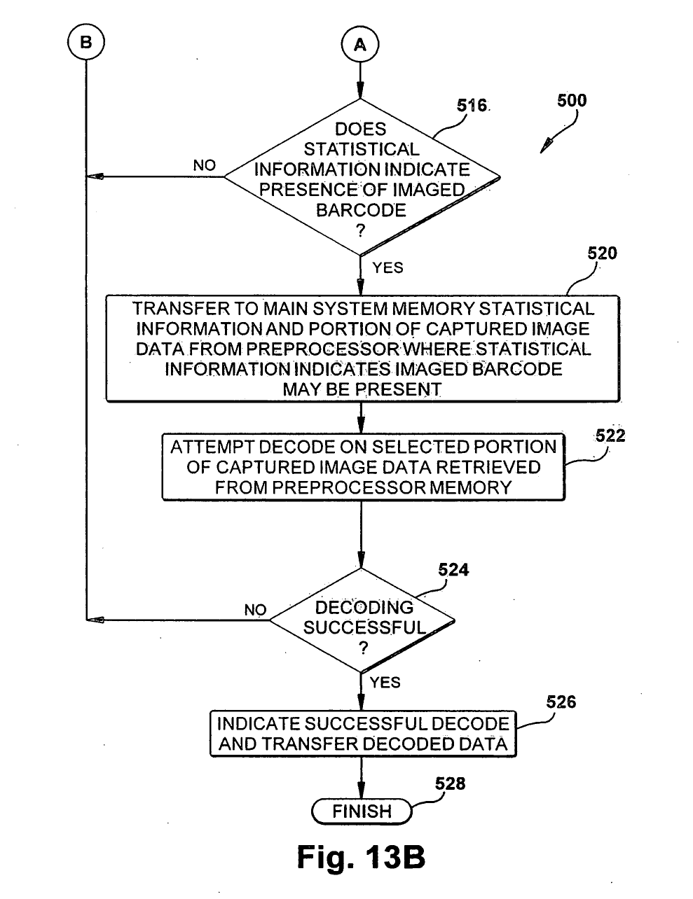

An alternate exemplary embodiment of a method of operation of the scanner 300 and particularly the image processing system 330 is shown generally at 500 in the flowchart of FIG. 13. Steps 500, 502, 504, 506, 508, 510, 512 correspond to steps 400, 402, 404, 406, 408, 410, 412 in the previously discussed operating embodiment. In the present embodiment, the preprocessor 332 is more intelligent and in addition to generating statistical information/data SI, at step 514, the preprocessor 332 additionally analyzes the statistical information SI.

At step 516, the preprocessor 332 analyzes the statistical data/information SI to determine, at step 418, whether the statistical information SI indicates that an imaged bar code 308′ or a portion of an imaged bar code 308′ is present in one or more of the series of image frames IF1-IF6. If the answer to the determination by the preprocessor 332 at step 516 is yes, then, at step 520, the preprocessor 332 will transfer a portion 350′ of the captured image data 350 is stored in the preprocessor memory 334 that corresponds to the location or locations of one or more image frames IF1-IF6 where the preprocessor 336 has determined an imaged bar code 308′ or portion thereof is present.

At step 516, if it is determined by the preprocessor 332 that the statistical information SI does not indicate the present of an imaged bar code 308′, then the process returns to step 506 where newly generated image data 350 is analyzed by the preprocessor 332. It should be noted, of course, that during the course of a bar code imaging/reading session, the preprocessor memory 334 continuously stores image data 350 because image data is continually generated by the imaging camera C1-C6 during the session and, correspondingly, the preprocessor 332 continuously analyzes the generated image data 350 and continues to generate statistical information SI regarding the generated image data.

At step 522, when the selected portion 350′ of the captured image data 350 corresponding to an imaged bar code 308′ is transferred from the preprocessor memory 334 to the main processor memory 338, the main system processor 338 (including the decoder 340) acts on the selected image data 350′ and attempts to decode the imaged bar code 308′. At step 524, if decoding of the imaged bar code 308′ from the selected image data is successful, then, at step 526, an indication is given of a successful decode and, at step 458, the imaging session is terminated. If at step 524, decoding is not successful, the process reverts back to step 406, as discussed previously.

Although the present invention has been described with a certain degree of particularity, it should be understood that various changes can be made by those skilled in the art without departing from the spirit or scope of the invention as hereinafter claimed.

What is claimed is:

1. A multicamera imaging-based bar code reader for imaging a target bar code on a target object, the bar code reader comprising:
a housing supporting a plurality of transparent windows and defining an interior region, a target object being presented to the plurality of windows for imaging a target bar code;
an imaging system including a plurality of camera assemblies coupled to an image processing system, each camera assembly of the plurality of camera assemblies being positioned within the housing interior position and defining a field of view, each camera assembly including a sensor array and an imaging lens assembly for focusing the field of view of the camera assembly onto the sensor array, for each camera assembly of the plurality of camera assemblies, the sensor array being read out to generate image frames of the field of view of the camera assembly;
an image process system including a preprocessor and a preprocessor memory coupled to the preprocessor, a main system processor and a main system memory coupled to the processor, the preprocessor simultaneously receiving captured image data corresponding to image frames of each of the plurality of camera assemblies and storing the captured image data in the preprocessor memory;
the preprocessor generating statistical information regarding the captured image data stored in the preprocessor memory, the statistical information being analyzed by a selected one of the preprocessor and the main system processor to identify regions of the image frames wherein an image of the target bar code or a part thereof may be present;
the preprocessor transferring portions of captured image data corresponding to identified regions of the image frames to the main system memory; and
the main system processor operating on the portions of the captured image data transferred to the main system memory and attempting to decode an image of the target bar code.

2. The bar code reader of claim 1 wherein the main system processor analyzes the statistical information generated by the preprocessor and determines if an imaged bar code or a part thereof is present in the captured image data.

3. The bar code reader of claim 2 wherein the main system processor instructs the preprocessor to transfer portions of captured image data corresponding to identified regions of the image frames wherein an image of the target bar code or a part thereof may be present to the main system memory.

4. The bar code reader of claim 1 wherein the preprocessor analyzes the statistical information and determines if an imaged bar code or part thereof is present in the captured image data.

5. The bar code reader of claim 4 wherein the preprocessor transfers portions of captured image data corresponding to identified regions of the image frames wherein an image of the target bar code or a part thereof may be present to the main system memory.

6. The bar code reader of claim 1 wherein the preprocessor is coupled to the main system memory via a DMA channel.

7. The bar code reader of claim 1 wherein the processor includes decoding circuitry for decoding an image of the target bar code.

8. A method of operating a multicamera imaging-based bar code reader for imaging a target bar code on a target object, the steps of the method comprising:
providing a reader including a housing supporting a plurality of transparent windows and defining an interior region, a target object being presented to the plurality of windows for imaging a target bar code; an imaging system including a plurality of camera assemblies coupled to an image processing system, each camera assembly of the plurality of camera assemblies being positioned within the housing interior position and defining a field of view, each camera assembly including a sensor array and an imaging lens assembly for focusing the field of view of the camera assembly onto the sensor array; for each camera assembly of the plurality of camera assemblies, the sensor array being read out to generate image frames of the field of view of the camera assembly at periodic intervals;
providing an image processing system including a preprocessor and a preprocessor memory coupled to the preprocessor, an image process system including a main processor and a main system memory coupled to the processor;
operating the reader to image a target bar code on a target object, for each camera assembly of the plurality of camera assemblies, the sensor array being read out at a predetermined frame rate to generate image frames of the field of view of the camera assembly at periodic intervals, the preprocessor simultaneously receiving captured image data corresponding to image frames of each of the plurality of camera assemblies and storing the captured image data in the preprocessor memory; the preprocessor generating statistical information regarding the captured image data stored in the preprocessor memory, the statistical information being analyzed by a selected one of the preprocessor and the main system processor to identify regions of the image frames wherein an image of the target bar code or a part thereof may be present; the preprocessor transferring portions of captured image data corresponding to identified regions of the image frames to the main system memory; and the main system processor operating on the portions of the captured image data transferred to the main system memory and attempting to decode an image of the target bar code.

9. The method of claim 8 wherein the main system processor analyzes the statistical information generated by the preprocessor and determines if an imaged bar code or a part thereof is present in the captured image data.

10. The method of claim 9 wherein the main system processor instructs the preprocessor to transfer portions of captured image data corresponding to identified regions of the image frames wherein an image of the target bar code or a part thereof may be present to the main system memory.

11. The method of claim 8 wherein the preprocessor analyzes the statistical information and determines if an imaged bar code or part thereof is present in the captured image data.

12. The method of claim 11 wherein the preprocessor transfers portions of captured image data corresponding to identified regions of the image frames wherein an image of the target bar code or a part thereof may be present to the main system memory.

13. An imaging system for use in multicamera imaging-based bar code reader having a housing supporting a plurality of transparent windows and defining an interior region, a target object being presented to the plurality of windows for imaging a target bar code on a target object, the imaging system comprising:
a plurality of camera assemblies coupled to an image processing system, each camera assembly of the plurality of camera assemblies being positioned within the housing interior position and defining a field of view, each camera assembly including a sensor array and an imaging lens assembly for focusing the field of view of the camera assembly onto the sensor array, for each camera assembly of the plurality of camera assemblies, the sensor array being read out to generate image frames of the field of view of the camera assembly;
an image process system including a preprocessor and a preprocessor memory coupled to the preprocessor, a main processor and a main system memory coupled to the processor, the preprocessor simultaneously receiving captured image data corresponding to image frames of each of the plurality of camera assemblies and storing the captured image data in the preprocessor memory;
the preprocessor generating statistical information regarding the captured image data stored in the preprocessor memory, the statistical information being analyzed by a selected one of the preprocessor and the main system processor to identify regions of the image frames wherein an image of the target bar code or a part thereof may be present;
the preprocessor transferring portions of captured image data corresponding to identified regions of the image frames to the main system memory; and
the main system processor operating on the portions of the captured image data transferred to the main system memory and attempting to decode an image of the target bar code.

14. The imaging system of claim 13 wherein the main system processor analyzes the statistical information generated by the preprocessor and determines if an imaged bar code or a part thereof is present in the captured image data.

15. The imaging system of claim 14 wherein the main system processor instructs the preprocessor to transfer portions of captured image data corresponding to identified regions of the image frames wherein an image of the target bar code or a part thereof may be present to the main system memory.

16. The imaging system of claim 13 wherein the preprocessor analyzes the statistical information and determines if an imaged bar code or part thereof is present in the captured image data.

17. The imaging system of claim 16 wherein the preprocessor transfers portions of captured image data corresponding to identified regions of the image frames wherein an image of the target bar code or a part thereof may be present to the main system memory.

18. A multicamera imaging-based bar code reader for imaging a target bar code on a target object, the bar code reader comprising:
a housing means supporting a plurality of transparent windows and defining an interior region, a target object being presented to the plurality of windows for imaging a target bar code;
an imaging system means including a plurality of camera assemblies means coupled to an image processing system, each camera assembly means of the plurality of camera assemblies means being positioned within the housing interior position and defining a field of view, each camera assembly means including a sensor array and an imaging lens assembly for focusing the field of view of the camera assembly onto the sensor array, for each camera assembly means of the plurality of camera assemblies means, the sensor array being read out to generate image frames of the field of view of the camera assembly means;
an image process system means including a preprocessor means and a preprocessor memory means coupled to the preprocessor means, a main processor means and a main system memory means coupled to the processor means, the preprocessor means simultaneously receiving captured image data corresponding to image frames of each of the plurality of camera assemblies means and storing the captured image data in the preprocessor memory means;
the preprocessor means generating statistical information regarding the captured image data stored in the preprocessor memory means, the statistical information being analyzed by a selected one of the preprocessor means and the main system processor means to identify regions of the image frames wherein an image of the target bar code or a part thereof may be present;
the preprocessor means transferring portions of captured image data corresponding to identified regions of the image frames to the main system memory means; and
the main system processor means operating on the portions of the captured image data transferred to the main system memory means and attempting to decode an image of the target bar code.

19. The bar code reader of claim 18 wherein the main system processor means analyzes the statistical information generated by the preprocessor means and determines if an imaged bar code or a part thereof is present in the captured image data.

20. The bar code reader of claim 19 wherein the main system processor means instructs the preprocessor means to transfer portions of captured image data corresponding to identified regions of the image frames wherein an image of the target bar code or a part thereof may be present to the main system memory.

21. The bar code reader of claim 18 wherein the preprocessor means analyzes the statistical information and determines if an imaged bar code or part thereof is present in the captured image data.

22. The bar code reader of claim 21 wherein the preprocessor means transfers portions of captured image data corresponding to identified regions of the image frames wherein an image of the target bar code or a part thereof may be present to the main system memory means.

23. Computer-readable media having computer-executable instructions for performing a method of operating a multicamera imaging-based bar code reader for imaging a target bar code on a target object wherein the reader includes a housing supporting a plurality of transparent windows and defining an interior region, a target object being presented to the plurality of windows for imaging a target bar code; an imaging system including a plurality of camera assemblies coupled to an image processing system, each camera assembly of the plurality of camera assemblies being positioned within the housing interior position and defining a field of view, each camera assembly including a sensor array and an imaging lens assembly for focusing the field of view of the camera assembly onto the sensor array, for each camera assembly of the plurality of camera assemblies, the sensor array being read out to generate image frames of the field of view of the camera assembly; and an image process system including a preprocessor and a preprocessor memory coupled to the preprocessor, a main processor and a main system memory coupled to the processor, the steps of the method comprising:
operating the reader to image a target bar code on a target object, for each camera assembly of the plurality of camera assemblies, the sensor array being read out at a predetermined frame rate to generate image frames of the field of view of the camera assembly at periodic intervals, the preprocessor simultaneously receiving captured image data corresponding to image frames of each of the plurality of camera assemblies and storing the captured image data in the preprocessor memory; the preprocessor generating statistical information regarding the captured image data stored in the preprocessor memory, the statistical information being analyzed by a selected one of the preprocessor and the main system processor to identify regions of the image frames wherein an image of the target bar code or a part thereof may be present; the preprocessor transferring portions of captured image data corresponding to identified regions of the image frames to the main system memory; and the main system processor operating on the portions of the captured image data transferred to the main system memory and attempting to decode an image of the target bar code.
